(19) United States
(12) Patent Application Publication
(10) Pub. No.: US 2006/0210667 A1
(43) Pub. Date: Sep. 21, 2006

(54) High strength beer having winey beery character

(75) Inventor: Alok Basu, Bangalore (IN)

Correspondence Address: THE WEBB LAW FIRM, P.C., 700 KOPPERS BUILDING, 436 SEVENTH AVENUE, PITTSBURGH, PA, 15219, US

(73) Assignee: United Breweries Limited, Bangalore, IN (US)

(21) Appl. No.: 11/283,494

(22) Filed: Nov. 18, 2005

Related U.S. Application Data
(60) Provisional application No. 60/633,000, filed on Dec. 3, 2004.

(51) Int. Cl. C12C 11/00

(52) U.S. Cl. 426/11

(57) ABSTRACT

The present invention relates to a process for producing a high strength beer having a winey beery character. The process comprises the several steps of preparing a mash from a milled malt and liquor with additives to provide mash with an acidic pH; subjecting the mash to the step of lautering to obtain a clear wort; adding the wort to a sugar solution and subjecting the blend to the step of boiling while adding citric acid and caramel, and while also adjusting wort gravity; transferring the wort to a whirlpool; adding activated yeast to the wort and passing the wort through PHE in the presence of aeration and then subjecting the wort to fermentation; lagering the wort to remove yeast; and filtering the fermented wort.

This application claims the benefit of U.S. Provisional Application Ser. No. 60/633,000, filed Dec. 3, 2004, which is incorporated herein by reference in its entirety.

### BACKGROUND OF THE INVENTION

1. Field of the Invention

The present invention relates to a process for producing a high strength beer having a winey beery character.

2. Description of Related Art

It is known in the art that the process for producing beer comprises five (5) general steps of mashing, boiling, fermenting, maturing and filtering. The first step of mashing comprises milling the malt, preparing a mash slurry from the milled malt and lautering the mashed malt to obtain a wort. The second step of boiling comprises boiling the wort with sugar to obtain a required gravity. The third step of fermenting comprises fermenting and aerating the hopped wort in the presence of yeast and then separating the yeast from the fermented wort. The fourth step of maturing comprises conditioning the fermented wort, which is beer. The fifth step of filtering comprises filtering the beer.

In the first mashing step of producing beer, barley malt is first milled into grist and then fed into a mash tun, where the grist is mixed with hot water to form a slurry or a mash. The slurry or mash is stirred. A saccharified mash is obtained. The saccharified mash is transferred into a lauter tun having a perforated base, which retains the spent mash and allows the clear extract (wort) to filter through, which is collected in a kettle.

In the second boiling step of producing beer, along with sugar, the extract or wort in the kettle is boiled with either direct steam or steam coils. Solid particles, which are proteins, are separated by a whirlpool separator, wherein the wort is led into the vessel in a tangential flow that creates a whirlpool effect. The solid particles pile up in the center of the vortex of the whirlpool effect, and the wort is then decanted off.

In the third fermenting step of producing beer, the wort is subsequently cooled to a suitable fermentation temperature, which depends on the type of beer to be produced. The wort is aerated with compressed air to provide oxygen for fermentation, pitched or mixed with the chosen yeast, and then transferred into large fermentation tanks. In the fermentation tanks, the yeast acts to ferment the wort. The process of fermentation generally takes four to five days, during which time, the yeast multiplies and vigorously ferments the wort sugars to produce ethyl alcohol and carbon dioxide. At the end of fermentation, the yeast settles to the bottom of the fermentation tank, and gas production slows down. The yeast is then separated from the fermented wort, which is now beer, by drawing the yeast off from the bottom of the fermentation tank and by transferring the fermented wort, or beer, into a conditioning or maturation tank.

In the fourth maturing step of producing beer, maturation occurs in stainless steel maturation tanks where any residual yeast is induced to carry out secondary fermentation by priming the beer with sugar. The fermented beer is chilled to 0° C. and transferred to lager tanks, where it matures. During this time, skilled artisans employ a number of biochemical transformations to impart stable flavor characteristics to the beer and remove many of the undesirable flavors that develop during fermentation.

In the fifth filtering step of producing beer and after the end of conditioning or maturation, the beer is subjected to a process of filtration to produce a clear, amber liquid. The filtering step may be carried out in two steps including removing suspended yeast cells with coarse filtration and removing all particulate matter with fine filtration. Typically, diatomaceous earth or Kieselguhr is used as the filtration medium. The filtration equipment used for the purpose is varied, and ranges from plate and frame filters to leaf or candle filters.

There is a present need for a process for producing a high strength beer having a winey beery character.

### SUMMARY OF THE INVENTION

The present invention provides a process for producing a high strength beer having a winey beery character. In particular, the present invention provides a process for manufacturing a beer having high alcohol strength and having a winey beery character, without a bitter taste. The beer produced by the process of manufacture is smooth and does not cause heaviness after drinking and has a mellow and clear taste and has no off flavor.

### DESCRIPTION OF THE PREFERRED EMBODIMENTS

In accordance with the present invention, a process is provided for the preparation of beer having a high alcohol strength with a winey beery character.

Generally, the process comprises the several steps of preparing a mash from a milled malt and liquor with additives to provide mash with an acidic pH; subjecting the mash to the step of lautering to obtain a clear wort; adding the wort to a sugar solution and subjecting the blend to the step of boiling while adding citric acid and caramel and while also adjusting wort gravity; transferring the wort to a whirlpool; adding activated yeast to the wort and passing the wort through PHE in the presence of aeration and then subjecting the wort to fermentation; lagering the wort to remove yeast; and filtering the fermented wort.

The first step of the present invention comprises preparing a mash from a milled malt and liquor with additives to provide mash with an acidic pH. Prior to preparing the mash, malt is first milled in a coarse mill that crushes the malt to form grist and to expose starch of the malt. The grist is combined with water to form a mash in a mash tun. The mash is prepared at a suitable malt to liquor ratio. For example, the malt to liquor ratio of 1:7 may be used for preparing a mash. During the step of preparing a mash, additives are added to the mash to give the mash a pH of 5.4. The additives can include gypsum, calcium chloride, promalt, formaldehyde and lactic acid. The step of preparing the mash is carried out in the mash tun by heating the mash to extract starch from the grist and to convert the starch with enzymes into fermentable sugar. The heating of the mash occurs in a sequence of heating steps for various periods of time. For example, the mash is initially heated in the mash tun at 45° C. for 15 min, followed by the mash being heated at 52° C. for 30 min, then at 65° C. for 60 min, and then at 72° C. for 30 min. At the end of the sequence of heating steps, the temperature is raised to 76° C. and mash off occurs. Mash off is a heating step used to inactivate the enzymes accountable for converting starch into sugars.

The second step of the present invention comprises subjecting the mash to the step of lautering to obtain a clear wort. The mash is transferred to a lautering tun having a perforated base. The wort is the liquid extracted from the mash. Particularly, the wort is a combination of the water added to create the mash and the soluble sugars obtained by enzymatically converting the starch extracted from the grist by heating the mash. Lautering is the process of washing the soluble sugars away from the grist of the mash in a lautering tun by circulated filtration. At the bottom of the lautering tun, the perforated base filters wort from the grist and other particulate matter in the mash. The wort is filtered through the perforated base, which traps pieces of grist and malt husk that form a grain bed. The wort is pumped from the bottom of the lautering tun and poured back on top of the mash in the lautering tun. The wort is recirculated through the perforated base and grain bed several times to obtain a clear wort. The wort becomes clear after multiple steps of recirculation of the wort through the screen and grain bed. The clear wort is then removed from the lautering tun and collected in a kettle. While the clear wort is being removed from the lautering tun, sparging occurs, which involves spraying hot water on top of the grain bed to rinse any residual sugars out of the grain bed. The hot water used in sparging can be heated to a temperature between 76-78° C. The residual sugars mixed with the hot water are collected in the kettle with the clear wort. The end gravity of the collected wort should be between 2.0-2.20° P.

The third step of the present invention comprises adding the clear wort to a sugar solution and subjecting the combined wort and sugar solution to the step of boiling in the kettle. Sugar is dissolved and a wort and sugar solution dip is made to the required gravity and volume. The wort and sugar solution dip is boiled vigorously in the kettle for a period of time, which may be, for example, thirty (30) minutes. The third step also comprises adding citric acid and caramel to the boiling wort and sugar solution dip, and adjusting wort gravity. Prior to the completion of the boiling step, quantities of citric acid and caramel are added while boiling to make up the color of the wort and sugar solution to 7-7.5 EBC. After the completion of the boiling step, whirlfloc is added to the wort to remove the haze of the wort caused by suspended proteins and other materials, and the final wort gravity is adjusted to a desired gravity.

The fourth step of the present invention comprises transferring the wort to a whirlpool after boiling. The wort is circulated in the whirlpool to precipitate solids suspended in the wort and to clarify the wort. The clarified wort is decanted off and transferred through pipes or tubes to a fermenter.

The fifth step of the present invention comprises adding activated yeast to the wort. Any form of yeast known to a skilled artisan is suitable. The yeast is activated by combining it with water and sugar. The yeast is dosed to the wort as the wort is being transferred in the pipes or tubes to the fermenter. After adding activated yeast, the fifth step also comprises passing the wort with activated yeast through PHE. While the wort is being passed through PHE, the wort is aerated online throughout the process of transferring the wort to the fermenter. During the transfer, yeast food at 5.5 g/hl and ammonium salt at 10.5 ghl are dosed into the wort. After the transfer of the wort to the fermenter, the fifth step of the invention comprises the further step of subjecting the wort to fermentation. Fermentation is carried out in a fermenter at 25-27° C. until the end gravity of the wort falls to a desired gravity, which, for example, can be 0.2° P.

The sixth step of the present invention comprises lagering the fermented wort to remove yeast. Lagering involves allowing the fermented wort, now beer, to age in a lagering tank for a suitable amount of time known to a skilled artisan. During the step of lagering, yeast is removed and additives such as biofine, biox, stabiquick/Lucilite and biofoam are added. The lagering temperature is maintained at 0 to 1° C. During lagering, a counter pressure of 0.5 to 1 kg is maintained on the lagering tank.

The seventh step of the present invention comprises filtering the fermented wort. During the step of filtering, residual yeast and other fines are removed from the fermented wort. The filtered product is filtered to achieve a haze below 0.4 EBC. The real extract (RE) of the product after filtration should not be less than 2.55° P for flavor. The RE of the product should not be more than 2.9° P, which may be monitored during the lagering stage. As soon as the product reaches the required RE, the product is immediately filtered, filled into bottles or other suitable containers, pasteurized and stored. At each stage of the unit operation including filling, air control and oxygen control is maintained by passing CO₂. DO should not be more than 0.1 ppm. During pasteurization, the temperature of the water in the pasteurization zone is, for example, 63.5° C. and the product temperature 62.5-63° C. This higher temperature is required for the inactivation of the yeast. The pasteurization unit is in the range of 23-25.

Product specifications:

| | | Unit Of | |
|---|---|---|---|
| SI. No. | Parameter | Measurement | Specifications |
| 1. | Original Gravity | °P | 14.8-15 |
| 2. | Apparent Extract | °P | 0.0-0.03 |
| 3. | Real Extract | °P | 2.55-2.9 |
| 4. | Alcohol | % v/v | 7.85-<8.0 |
| 5. | Colour | EBC | 5.5-5.7 |
| 6. | pH | | 3.12-3.2 |
| 7. | CO₂ | % v/v | 2.85-2.9 |

Calculation is provided for grist used for a high strength beer having a required alcohol content of 8.0% v/v. The original gravity (OG) is set between a range of 14.8 to 15 or 14.9-15. The grist ratio is malt to sugar (malt:sugar) in ranges. The range of the malt ratio is 18-20, and the range of the sugar ratio is 82 to 80. The extract ratio is malt extract to sugar extract (malt extract:sugar extract) in ranges. The range of the malt extract ratio is 14-16, and the range of the sugar extract ratio is 86-84. Reference to numerical values hereinabove is only by way of example and without intending to impose any restriction on the process of the present invention.

While the present invention is satisfied by embodiments in many different forms, there is described herein in detail the preferred embodiments of the invention, with the understanding that the present disclosure is to be considered as exemplary of the principles of the invention and is not intended to limit the invention to the embodiments illustrated. Various other embodiments will be apparent to and readily made by those skilled in the art without departing from the scope and spirit of the invention. The scope of the invention will be measured by the appended claims and their equivalents.

The invention claimed is:

1. A process for preparing a beer having high alcohol strength with a winery beery character, the process comprises the steps of:
a) preparing a mash from milled malt and liquor comprising adding additives to the mash to provide the mash with an acidic pH;
b) subjecting the mash to a step of lautering to obtain a clear wort;
c) adding the wort to a sugar solution and subjecting the wort and sugar solution to a step of boiling, the step of boiling comprises the further steps of adding citric acid and caramel and adjusting the wort gravity;
d) transferring the wort to a whirlpool to remove particulate matter;
e) passing the wort through PHE in the presence of aeration, adding activated yeast, and then subjecting the wort to a step of fermentation;
f) lagering the wort to remove yeast; and
g) subjecting the wort to filtration.

2. The method of claim 1, wherein the step of preparing the mash comprises preparing the mash with an acidic pH of 5.4 and at a temperature in a range between 45 to 76° C., the step of preparing the mash comprises preparing the mash at a ratio of malt to liquor of 1:7 during mashing and adding additives such as gypsum, calcium chloride, promalt, formaldehyde and lactic acid.

3. The method of claim 1, wherein the step of lautering comprises sparging water at 78° C. to obtain the wort with an end gravity of 2.0-2.2° P.

4. The method of claim 1, wherein the step of subjecting the wort to a step of fermentation comprises carrying out the fermentation between 25-27° C. until the gravity of the wort falls to 0.2° P.

5. The method of claim 1, wherein the step of lagering comprises lagering at a temperature in a range of 0 to 1° C. and maintaining a counter pressure in the range of 0.5 to 1 kg.
